(19) United States
(12) Patent Application Publication
(10) Pub. No.: US 2023/0127873 A1
(43) Pub. Date: Apr. 27, 2023

(54) SYSTEM FOR DETECTING AIRBORNE OBJECTS WITHIN A SHARED FIELD OF VIEW BETWEEN TWO OR MORE TRANSCEIVERS

(71) Applicant: The Boeing Company, Chicago, IL (US)

(72) Inventors: Ralf Rene Cabos, Hainburg (DE); Nils Kneuper, Bergkamen (DE)

(21) Appl. No.: 17/474,798

(22) Filed: Sep. 14, 2021

Related U.S. Application Data
(63) Continuation-in-part of application No. 16/735,223, filed on Jan. 6, 2020, now abandoned.

(51) Int. Cl. G01S 13/933; G01S 13/87

(52) U.S. Cl. CPC G01S 13/933; G01S 13/87

(57) ABSTRACT

A system for detecting airborne objects within a shared field of view includes a first transceiver and a second transceiver. The first transceiver is positioned in a first discrete location and has a first field of view that represents a detection area of the first transceiver and the second transceiver is positioned in a second discrete location and has a second field of view that represents the detection area of the second field of view. The first field of view and the second field of view intersect one another to create the shared field of view. Both the first transceiver and the second transceiver are configured to emit an array of signals towards the shared field of view. Each signal of the array of signals includes a unique signature including information for determining an actual distance between either the first transceiver or the second transceiver and the airborne object.

### CROSS-REFERENCE TO RELATED APPLICATIONS

This application is a continuation-in-part of U.S. application Ser. No. 16/735,223 filed on Jan. 6, 2020.

### INTRODUCTION

The present disclosure relates to a system for detecting the presence of airborne objects. More particularly, the present disclosure is directed towards a system for detecting the presence of airborne objects within a shared field of view between two or more transceivers.

### BACKGROUND

Birds are often attracted to airports and the area around airports, as they tend to view the area as an ideal place for resting, gathering in flocks, or hiding from predators. However, birds interfere with an airport's runways and airways. For example, a bird may accidently fly into the path of an aircraft either during takeoff or landing. In addition to birds, other airborne objects such as drones may also intersect the path of an aircraft during takeoff or landing. For example, a rouge drone may cause large scale interruptions to flight schedules.

As a result, it is common for an airport to employ one or more individuals to monitor the area where aircraft arrive and depart. However, it is often difficult for an individual to determine if an airborne object may intersect an aircraft's path. In another approach, the individuals may be provided with lights or lasers in an effort to try and distract and chase birds away. However, this approach is labor intensive. Furthermore, an individual may easily miss a bird or a flock of birds since it is difficult, if not impossible, to observe the entire airport.

### SUMMARY

According to several aspects, a system for detecting airborne objects within a shared field of view is disclosed. The system includes a first transceiver positioned in a first discrete location having a first field of view that represents a detection area of the first transceiver. The system also includes a second transceiver positioned in a second discrete location having a second field of view represents the detection area of the second field of view. The first field of view and the second field of view intersect one another to create the shared field of view. Both the first transceiver and the second transceiver are configured to emit an array of signals towards the shared field of view. The system also includes one or more processors in electronic communication with the first transceiver and the second transceiver and a memory coupled to the one or more processors. The memory stores data into a database and program code that, when executed by the one or more processors, causes the system to instruct either the first transceiver or the second transceiver to emit the array of signals, where the array of signals are configured to reflect from airborne objects located within the shared field of view to create one or more reflected signals. Each signal of the array of signals includes a unique signature including information for determining an actual distance between either the first transceiver or the second transceiver and the airborne object within three-dimensional space. The system is further caused to monitor the first transceiver and the second transceiver for the one or more reflected signals and receive an indication that at least one of the first transceiver and the second transceiver has received the one or more reflected signals. Finally, in response to receiving the indication, the system generates a notification indicating an airborne object is located within the shared field of view.

In another aspect, a system for detecting airborne objects along a runway for landing and takeoff of an aircraft is disclosed, where the aircraft follows a flight path during takeoff or landing. The system includes a first transceiver positioned in a first discrete location at a first end of the runway having a first field of view that represents a detection area of the first transceiver. The system includes a second transceiver positioned in a second discrete location at a second end of the runway having a second field of view represents the detection area of the second field of view. The first field of view and the second field of view intersect one another to create a shared field of view. Both the first transceiver and the second transceiver are configured to emit an array of signals towards the shared field of view. The system also includes one or more processors in electronic communication with the first transceiver and the second transceiver and a memory coupled to the one or more processors. The memory stores data into a database and program code that, when executed by the one or more processors, causes the system to instruct either the first transceiver or the second transceiver to emit the array of signals. The array of signals are configured to reflect from airborne objects located within the shared field of view to create one or more reflected signals. Each signal of the array of signals includes a unique signature including information for determining an actual distance between either the first transceiver or the second transceiver and the airborne object within three-dimensional space. The system is further caused to monitor the first transceiver and the second transceiver for the one or more reflected signals and receive an indication that at least one of the first transceiver and the second transceiver has received the one or more reflected signals. Finally, in response to receiving the indication, the system generates a notification indicating an airborne object is located within the shared field of view, where at least a portion of the flight path of the aircraft is located within the shared field of view.

In yet another aspect, a method for detecting airborne objects within a shared field of view between a first transceiver and a second transceiver is disclosed. The method includes instructing, by a computer, either the first transceiver or the second transceiver to emit an array of signals. The array of signals are configured to reflect from airborne objects located within the shared field of view to create one or more reflected signals. The shared field of view is created as a first field of view of the first transceiver and a second field of view of a second transceiver intersect one another, and each signal of the array of signals includes a unique signature includes information for determining an actual distance between either the first transceiver or the second transceiver and the airborne object within three-dimensional space. The method also includes monitoring, by the computer, the first transceiver and the second transceiver for the one or more reflected signals. The method further includes receiving, by the computer, an indication that at least one of the first transceiver and the second transceiver has received the one or more reflected signals. Finally, in response to receiving the indication, the method includes generating a notification indicating an airborne object is located within the shared field of view.

The features, functions, and advantages that have been discussed may be achieved independently in various embodiments or may be combined in other embodiments further details of which can be seen with reference to the following description and drawings.

### BRIEF DESCRIPTION OF THE DRAWINGS

The drawings described herein are for illustration purposes only and are not intended to limit the scope of the present disclosure in any way.

FIG. 1A is a schematic diagram illustration a top view of a system for detecting airborne objects, according to an exemplary embodiment;

FIG. 1B is a schematic diagram illustration a side view of the system shown in FIG. 1A for detecting airborne objects, according to an exemplary embodiment;

FIG. 2 is a schematic diagram of a first transceiver emitting an array of signals, according to an exemplary embodiment;

FIG. 3 is a schematic diagram of a second transceiver emitting an array of signals, according to an exemplary embodiment;

FIG. 4 is a schematic diagram of an airborne object detected within a shared field of view between two transceivers, according to an exemplary embodiment;

FIG. 5 is a schematic diagram of a rasterized representation of the shared field of view, according to an exemplary embodiment;

FIGS. 6A and 6B illustrate exemplary pixels that are part of the rasterized representation shown in FIG. 5, according to an exemplary embodiment;

FIG. 7 illustrates an alternative embodiment of the system shown in FIGS. 1A and 1B, where the transceivers are angled in different directions, according to an exemplary embodiment;

FIG. 8 illustrates another alternative embodiment of the system shown in FIGS. 1A and 1B, where three transceivers are used, according to an exemplary embodiment;

FIG. 9 is a process flow diagram illustrating a method for detecting objects in the shared field of view, according to an exemplary embodiment;

FIG. 10 is a process flow diagram illustrating a method for generating a rasterized image of the shared field of view;

FIG. 11 is a schematic diagram illustrating one of the transceivers positioned relative to an airborne object, according to an exemplary embodiment;

FIG. 12 is a process flow diagram illustrating a method for determining an actual distance between the transceiver and the airborne object, according to an exemplary embodiment; and

FIG. 13 is an exemplary computer system for operating the disclosed system.

### DETAILED DESCRIPTION

The present disclosure is directed towards a system for detecting airborne objects. The system includes two or more transceivers. For example, in one embodiment, the system includes a first transceiver having a first field of view and a second transceiver having a second field of view, where the first field of view and the second view of view overlap to create a shared field of view. One of the transceivers emit an array of signals, where each signal is configured to reflect off an airborne object that is located within the shared field of view. A computer is in electronic communication with both the transceivers and determines when an airborne object is located within the shared field of view. In one embodiment, the system is used to detect airborne objects along a runway for an aircraft. Therefore, the computer generates a notification to flight management personnel informing them of a potential obstruction located within the immediate vicinity of an aircraft's trajectory during takeoff or landing.

The following description is merely exemplary in nature and is not intended to limit the present disclosure, application, or uses.

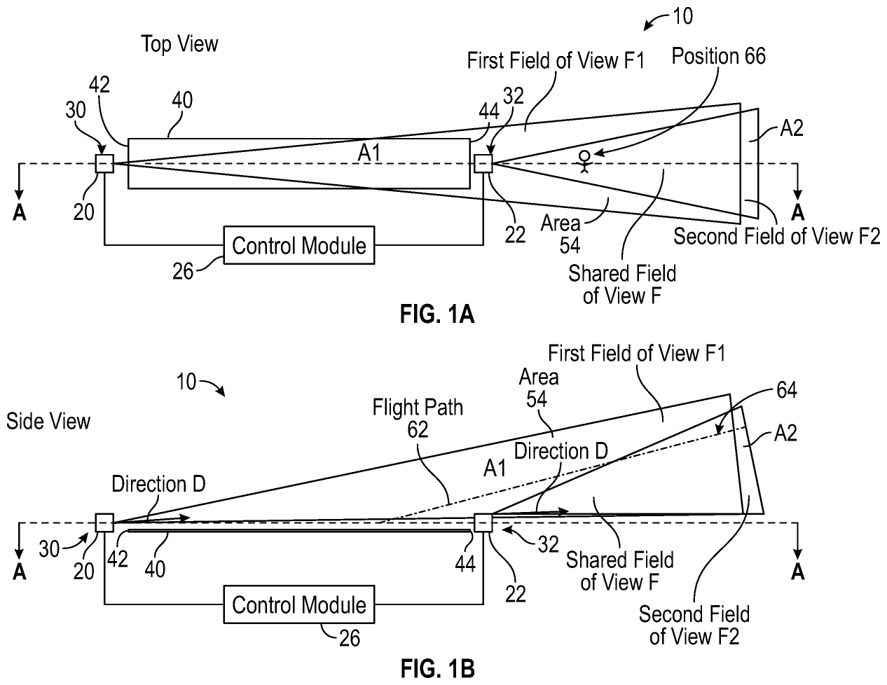

Referring to FIGS. 1A and 1B, a schematic diagram illustrating an exemplary system 10 for detecting airborne objects is shown, where FIG. 1A is a top view of the system 10 and FIG. 1B is a side view of the system 10. The system 10 includes two or more transceivers 20, 22. Specifically, FIGS. 1A and 1B illustrate a first transceiver 20 and a second transceiver 22 that are both in electronic communication with a control module 26. The first transceiver 20 is positioned in a first discrete location 30 and the second transceiver 22 is positioned in a second discrete location 32, where the first discrete location 30 and the second discrete location 32 are both located in the same plane as one another. In the non-limiting embodiment as shown in FIG. 1, the first transceiver 20 and the second transceiver 22 are both disposed along a runway 40, where the runway 40 is a strip of land for landing and takeoff of an aircraft. Specifically, the first discrete location 30 is at a first end 42 of the runway 40 and the second discrete location 32 is at a second end 44 of the runway 40.

In the non-limiting embodiments as shown in the figures, the system 10 monitors the runway 40 for airborne objects that intersect or are located within proximity of a flight path 62 (FIG. 1B). The flight path 62 is drawn as a dashed line and represents a path that an aircraft follows during takeoff or landing. Some examples of airborne objects include, but are not limited to, birds, drones, and ballistic objects. However, is to be appreciated that the disclosure is not limited to an airport runway and may be used in any application where airborne objects are detected.

The first transceiver 20 and the second transceiver 22 are both configured to transmit and receive wireless signals. Specifically, the first transceiver 20 and the second transceiver 22 are configured to emit and receive any type of electromagnetic signal, except for visible light. Some examples of electromagnetic signals include, but are not limited to, radio frequency signals, microwave signals, or infrared signals. Referring to FIGS. 1A, 1B, 2, and 3, the first transceiver 20 is configured to emit an array of signals 46 towards a first field of view F1. The first field of view F1 represents a first detection area A1 of the first transceiver 20. The first transceiver 20 is configured to detect wireless signals within the first detection area A1. In the embodiment as shown in the figures, the first detection area A1 of the first transceiver 20 includes a conical profile. Similarly, the second transceiver 22 is configured to emit the array of signals 46 towards a second field of view F2. The second field of view F2 represents a second detection area A2 of the second transceiver 22. The second detection area A2 of the second transceiver 22 also includes a conical profile.

It is to be appreciated that while both transceivers 20, 22 are configured to emit the array of signals 46, only one of the two transceivers 20, 22 emit the array of signals 46 towards the shared field of view F. Although only one of the transceivers 20, 22 emit the array of signals 46, it is to be appreciated that the shared field of view F is monitored by both transceivers 20, 22. Monitoring the shared field of view F with two more transceivers 20, 22 results in greater accuracy when compared to an area that is only monitored by a single transceiver.

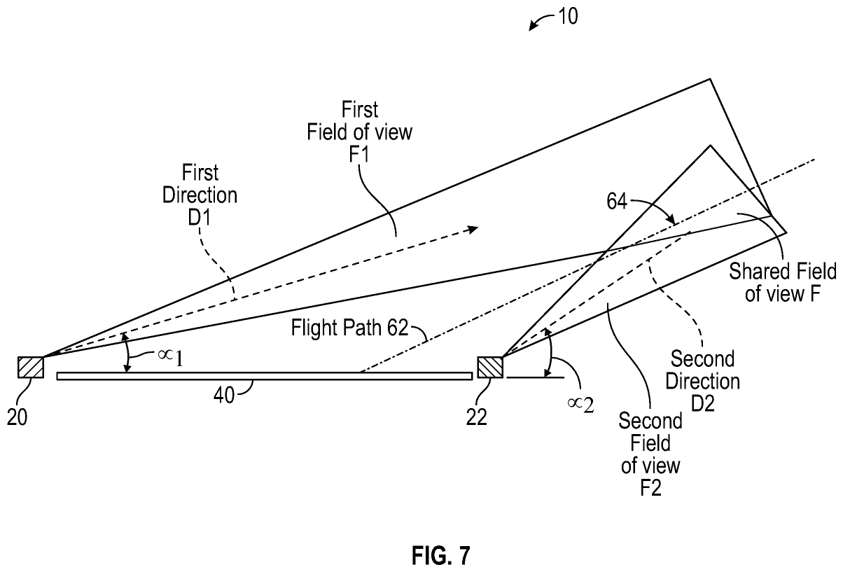

Referring to FIGS. 1A and 1B, the first field of view F1 and the second field of view F2 are both aligned with one another. Specifically, as seen in FIG. 1A, the first field of view F1 and the second field of view F2 are oriented concentrically with respect to one another. The first field of view F1 and the second field of view F2 are both oriented in identical directions D and are parallel with respect to one another. As such, both the first field of view F1 and the second field of view F2 share the same center axis A-A. However, it is to be appreciated that this embodiment is merely exemplary in nature. For example, in the embodiment as shown in FIG. 7, the first field of view F1 and the second field of view F2 are each oriented in different directions and include different heading angles.

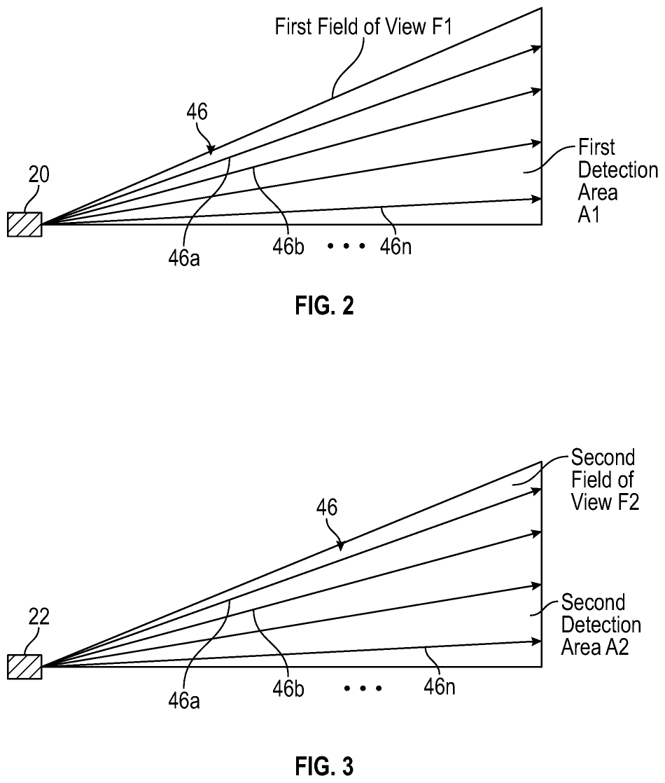

Referring to FIGS. 1A and 1B, the first field of view F1 and the second field of view F2 intersect one another to create a shared field of view F, where both the first transceiver 20 and the second transceiver 22 are both configured to emit the array of signals 46 (shown in FIGS. 2 and 3) towards the shared field of view F. Specifically, referring to FIGS. 1A, 1B, 2, and 3, the array of signals 46 emitted by the first transceiver 20 and the second transceiver 22 are both directed towards the shared field of view F. Referring to FIGS. 1A and 1B, the shared field of view F refers to an area where the first field of view F1 of the first transceiver 20 overlaps with the second field of view F2 of the second transceiver 22. However, the first field of view F1 also covers an area 54 that is not covered by the second field of view F2.

As seen in FIG. 1B, at least a portion 64 of the flight path 62 is located within the shared field of view F. In an embodiment, the entire flight path 62 is located within the shared view of view F. As explained below, the system 10 determines the presence of airborne objects that are present within the shared field of view F. The airborne object may be any item located in shared field of view F such as, for example, a bird, a drone, or a ballistic object. Since at least a portion 64 of the flight path 62 is located within the shared field of view F, it follows that the system 10 determines the presence of airborne objects that are within the immediate vicinity of an aircraft's trajectory during takeoff or landing.

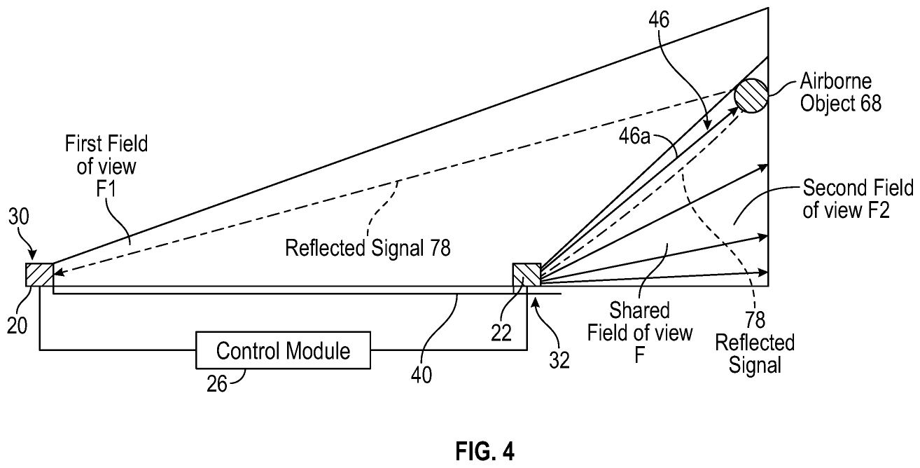

In the embodiment as shown in FIG. 4, the second transceiver 22 emits the array of signals 46. It is to be appreciated that while FIG. 4 illustrates the second transceiver 22 emitting the array of signals 46, in another embodiment the first transceiver 20 emits the array of signals 46 instead. The array of signals 46 are configured to reflect from airborne object 68 located within the shared field of view F to create one or more reflected signals 78. For example, in the embodiment as shown in FIG. 4, a selected signal 46a of the array of signals 46 reflects from the airborne object 68 and creates one or more reflected signals 78.

The one or more reflected signals 78 are received by both the first transceiver 20 and the second transceiver 22. The control module 26 monitors the first transceiver 20 and the second transceiver 22 for the one or more reflected signals 78. In response to receiving an indication that at least one of the first transceiver 20 and the second transceiver 22 has received the one or more reflected signals 78, the control module 26 generates a notification indicating the airborne object 68 is located within the shared field of view F. In one embodiment, the notification is sent to flight management personnel. Accordingly, the notification generated by the system 10 informs flight management personnel of a potential obstruction located within the immediate vicinity of an aircraft's trajectory during takeoff or landing. Therefore, the flight management personnel may take preventative action such as, for example, aborting a takeoff or landing of the aircraft.

In some instances, only one of the first transceiver 20 and the second transceiver 22 receive the reflected signals 78, however, it is to be appreciated that this typically occurs with objects that have a reduced radar signature. In the event only one of the transceivers 20, 22 receive the reflected signals 78, then the control module 26 still detects the airborne object 68 within the shared field of view F. However, in at least some embodiments, the control module 26 indicates an airborne object is detected with a reduced about of certainty or integrity.

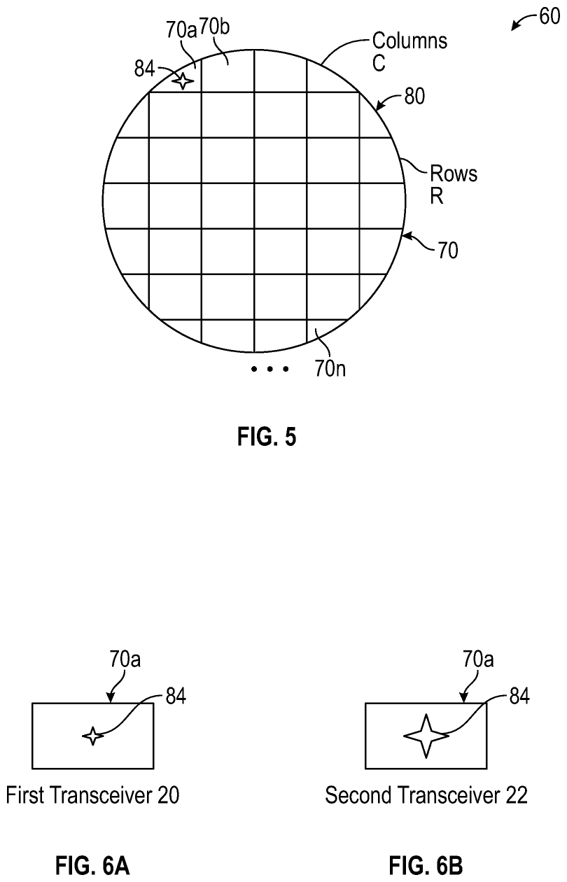

Furthermore, it is also to be appreciated that the second discrete location 32 of the second transceiver 22 is positioned closer to the shared field of view F when compared to the first discrete location 30 of the first transceiver 20. Thus, as explained below, the second transceiver 22 provides finer granularity to a rasterized representation 60 of the shared field of view F, which is shown in FIG. 5.

FIG. 5 is an exemplary illustration of the rasterized representation 60 of the shared field of view F generated by the control module 26. Referring to both FIGS. 1A and 5, the rasterized representation 60 represents the shared field of view F when observed from a position 66 facing towards the shared field of view F. It follows that any airborne objects located within the shared field of view F are shown within the rasterized representation 60. The rasterized representation 60 of the shared field of view F is divided into a series of smaller areas, which are referred to as a plurality of pixels 70. In the non-limiting embodiment as shown in FIG. 5, the pixels 70 are square-shaped cells arranged in a grid pattern 80 into a plurality of columns C and a plurality of rows R.

Referring to FIGS. 2, 3, 4, and 5, each of the plurality of pixels 70 correspond to an individual signal of the array of signals 46. Specifically, each pixel 70 of the rasterized representation 60 represents a corresponding signal 46n from the array of signals 46n. For example, in the embodiment as shown, the signal 46a (FIGS. 2 and 3) of the array of signals 46 corresponds to pixel 70a, which is located in a top left hand corner of the rasterized representation 60. Similarly, the signal 46b of the array of signals 46 corresponds to the pixel 70b, which is located directly to the left of the pixel 70a. It is to be appreciated that the grid pattern 80 of the rasterized representation 60 follows the orientation of the array of signals 46 within the shared field of view F. For example, the pixel 70a that is part of the grid pattern 80 is located at the upper left hand corner of the rasterized representation 60. It follows that the corresponding signal 46a is also oriented in a corresponding location within the shared field of view F.

Referring to FIGS. 1A, 1B, 4, and 5, the control module 26 renders each of the plurality of pixels 70 of the rasterized representation 60 sequentially as the control module 26 monitors the first transceiver 20 and the second transceiver 22 for the one or more reflected signals 78. As seen in FIG. 5, the one or more reflected signals 78 are mapped onto the grid pattern 80 of the rasterized representation 60 as an obstruction 84. Specifically, either the first transceiver 20 or the second transceiver 22 emit the array of signals 46 one at a time. For example, as seen in FIG. 2, the first transceiver 20 emits the signal 46a, which is part of the array of signals 46. The control module 26 monitors both transceivers 20, 22 for the reflected signals 78. In response to at least one of the transceivers 20, 22 receiving the reflected signal 78, then control module 26 marks the corresponding pixel 70a with the obstruction 84. The first transceiver 20 then emits the next signal 46b, which is part of the array of signals 46. This process continues until all of the signals in the array of signals 46 have been emitted.

FIGS. 6A and 6B illustrate the pixel 70a, where FIG. 6A illustrates the obstruction 84 as viewed by the first transceiver 20, and FIG. 6B illustrates the obstruction 84 as viewed by the second transceiver 22. The second transceiver 22 provides a larger and clearer representation of the airborne object 68. As mentioned above, since the second transceiver 22 is located closer to the airborne object 68 (FIG. 4), it follows that the second transceiver 22 produces a larger, clearer representation of the airborne object 68.

Referring to FIGS. 1A, 1B, and 4, the system 10 also determines a distance between the airborne object 68 and either the first transceiver 20 or the second transceiver 22. It is to be appreciated that background objects within the shared view of view F such as mountains, buildings, or other permanent structures are known, and are used as a reference when calculating distances between the transceivers 20, 22 and the airborne objects 68 (FIG. 4). The control module 26 records the time when the array of signals 46 are sent. For example, as seen in FIG. 4, the control module 26 records a first point in time when the selected signal 46a of the array of signals 46 is emitted by the second transceiver 22. The control module 26 also records a second point in time when the selected signal 46a is reflected from the airborne object 68 and is received by at least one of the first transceiver 20 and the second transceiver 22. The control module 26 then determines the distance between the airborne object 68 and either the first transceiver 20 or the second transceiver 22 based on the first point in time and the second point in time. Specifically, since electromagnetic signals travel at the speed of light, then the distance between the airborne object 68 and the first transceiver 20 or the second transceiver 22 is (c*t)/2, where c represents the speed of light and t represents the difference between the first point in time and the second point in time.

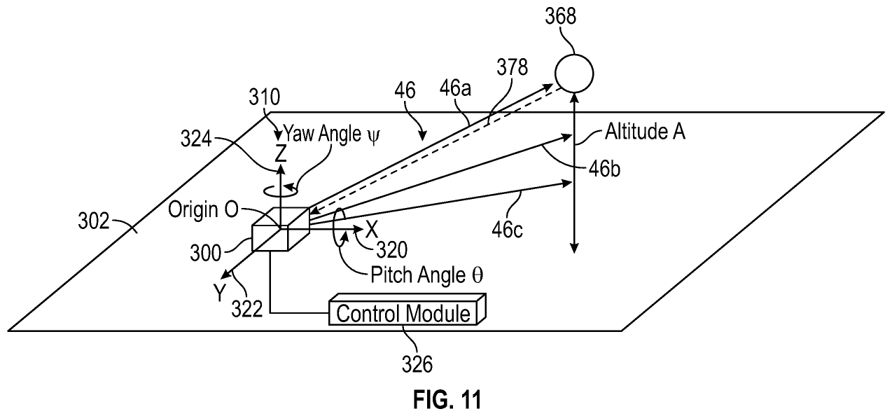

It is also to be appreciated that each signal of the array of signals 46 includes a unique signature. As explained below, the unique signature emitted by each signal of the array of signals 46 includes information for determining an actual distance between either the first transceiver 20 or the second transceiver 22 and the airborne object 68 within three-dimensional space. It is to be appreciated that the actual distance accounts for altitude A (seen in FIG. 11) measured between an airborne object 368 and plane 302 that the transceiver 20, 22 is located along. In one embodiment, the plane 302 represents a ground surface. For example, the plane 302 may be the runway 40 (seen in FIG. 1) for the landing and takeoff of an aircraft.

FIG. 7 is an alternative embodiment of the system shown in FIGS. 1A and 1B, where the first transceiver 20 and the second transceiver 22 are oriented in different directions and heading angles. For example, in the embodiment as shown, the first field of view F1 of the first transceiver 20 is oriented in a first direction D1 and a first heading angle α₁, the second field of view F2 of the second transceiver 22 is oriented in a second direction D2 at a second heading angle α₂, where the first direction D1 and the second direction D2 are non-parallel with respect to one another. In the embodiment as shown, the second heading angle α₂ of the second field of view F2 is greater than the first heading angle α₁ of the first field of view F1. The first field of view F1 and the second field of view F2 are oriented to accommodate the flight path 62, which is oriented at a steeper with respect to the runway 40 when compared to the flight path 62 shown in FIG. 1B.

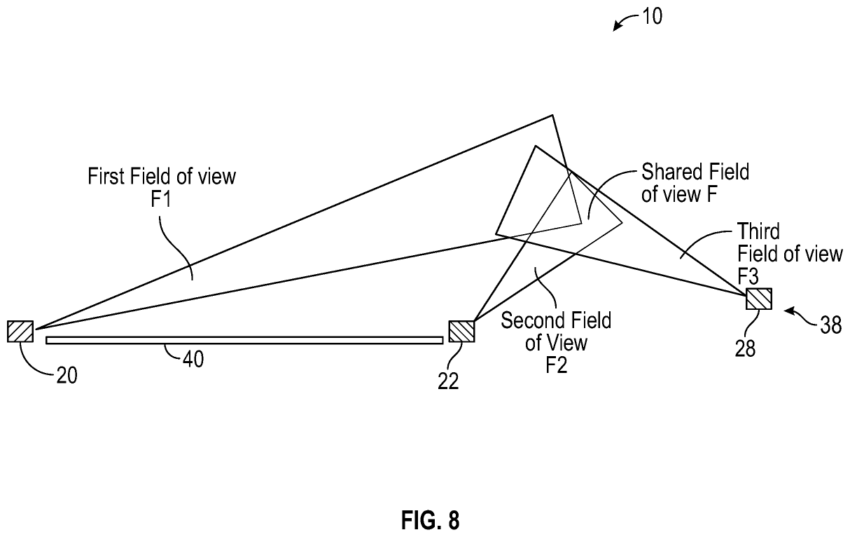

FIG. 8 illustrates yet another embodiment of the system 10 including a third transceiver 28 that is positioned in a third discrete location 38. The third transceiver 28 is also configured to emit and receive electromagnetic signals and includes a third field of view F3. Therefore, in the embodiment as shown, the first field of view F1, the second field of view F2, and the third field of view F3 intersect one another to create the shared field of view F. Although FIG. 8 illustrates three transceivers 20, 22, and 28, it is to be appreciated that the system 10 may include any number of multiple transceivers. It is also to be appreciated that additional transceivers may enhance or improve the accuracy of the system 10.

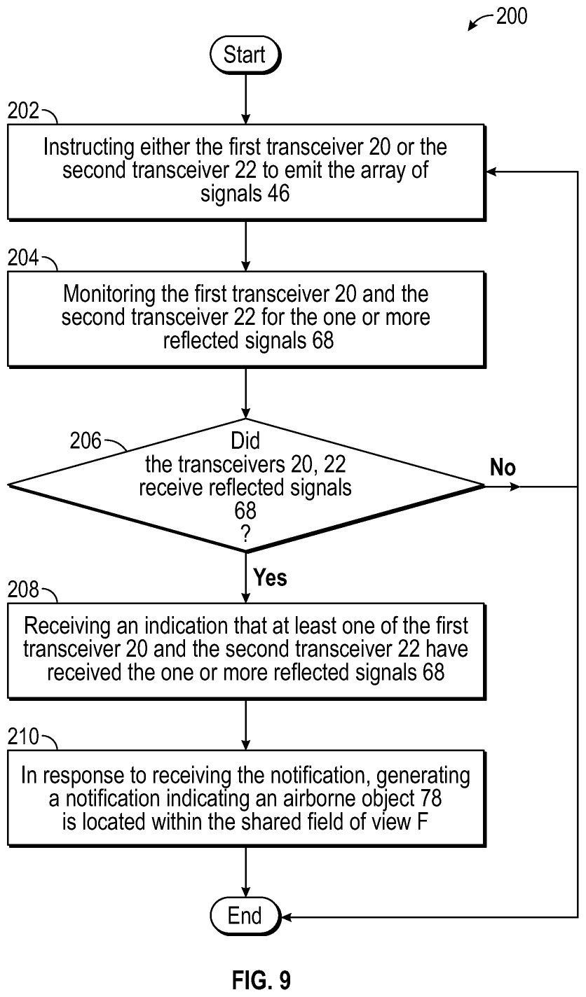

FIG. 9 is an exemplary process flow diagram illustrating a method 200 for detecting airborne objects within the shared field of view F between the first transceiver 20 and the second transceiver 22. Referring to FIGS. 1A, 1B, 2, 3, and 9, the method 200 begins at block 202. In block 202, the control module 26 instructs either the first transceiver 20 or the second transceiver 22 to emit the array of signals 46, where the array of signals 46 are configured to reflect from airborne objects located within the shared field of view F to create the one or more reflected signals 78 (FIG. 4). The method 200 may then proceed to block 204.

In block 204, the control module 26 monitors the first transceiver 20 and the second transceiver 22 for the one or more reflected signals 78. The method 200 may then proceed to decision block 206.

In decision block 206, if the control module 26 does not receive any reflected signals 78, then no airborne objects are disposed within the shared field of view F. The method 200 may then return to block 202 or, alternatively, the method 200 may terminate. However, in block 208, the control module 26 receives an indication that at least one of the first transceiver 20 and the second transceiver 22 has received the one or more reflected signals 78. The method 200 may then proceed to block 210.

In block 210, in response to receiving the indication, the control module 26 generates a notification indicating an airborne object is located within the shared field of view F. The method 200 may then terminate.

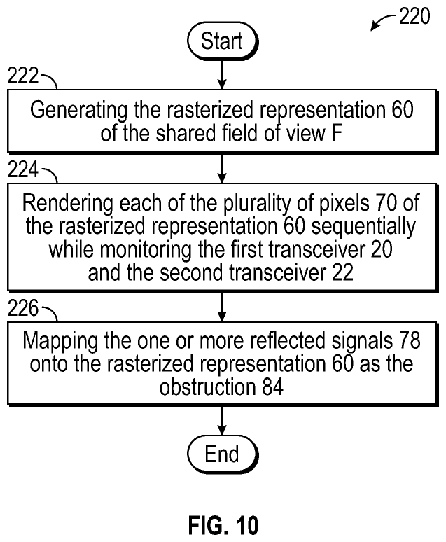

As seen in FIG. 5, the control module 26 also generates a rasterized representation 60 of the shared field of view F. FIG. 10 is a process flow diagram illustrating a method 220 of generating the rasterized representation 60. Referring to FIGS. 1A, 1B, 2, 3, 5, and 10, the method 220 may begin at block 222. In block 222, the control module 26 generates the rasterized representation 60 of the shared field of view F, where the rasterized representation 60 of the shared field of view F is divided into the plurality of pixels 70. As mentioned above, each of the plurality of pixels 70 correspond to an individual signal of the array of signals 46. The method 220 may then proceed to block 224.

In block 224, the control module 26 renders each of the plurality of pixels 70 of the rasterized representation 60 sequentially while monitoring the first transceiver 20 and the second transceiver 22 for the one or more reflected signals 78. The method 220 may then proceed to block 226.

In block 226, the control module 26 maps the one or more reflected signals 78 onto the rasterized representation 60 as the obstruction 84. The method 220 may then terminate.

Referring generally to the figures, the disclosed system provides various technical effects and benefits. Specifically, the disclosed system provides an objective approach for detecting airborne obstructions along an airport runway. Conventional solutions rely upon individuals to monitor runways, which tend to be ineffective since it is difficult for an individual to monitor multiple runways at once. Furthermore, the disclosed system also provides improved or enhanced accuracy when compared to a system that only relies upon a single transceiver to monitor the runways. The disclosed system may be used in all types of weather conditions as well. In contrast, sometimes individuals may not be able to effectively watch for birds or other objects during periods of severe weather or when visibility is limited.

Referring now to FIG. 11, determining the actual distance between one of the transceivers 20, 22 and the airborne object 68 shall now be described. As seen in FIG. 11, a specific transceiver 300 is located along the plane 302 at an origin O of a Cartesian coordinate system 310. In the example as shown, the individual signal 46a of the array of signals 46 emitted by the specific transceiver 300 reflects off an airborne object 368 to create a reflected signal 378. The specific transceiver 300 represents a transceiver that emits the individual signal 46a of the array of signals 46 that reflects off the airborne object 368 to create the reflected signal 378. Therefore, the specific transceiver 300 may represent the first transceiver 20 (FIG. 1), the second transceiver 22 (FIG. 1), the third transceiver 28 (FIG. 8), or any other transceiver that is part of the system 10.

The unique signature emitted by each signal of the array of signals 46 includes information for determining the actual distance between the specific transceiver 300 and the airborne object 368 within three-dimensional space. Specifically, the unique signature emitted by each signal of the array of signals 46 indicates an identity of the specific transceiver 300 that emits the array of signals 46, a time stamp, a pitch angle θ of the specific transceiver 300, a yaw angle Ψ of the specific transceiver 300, and coordinates of the specific transceiver 300. The control module 326 determines the actual distance between the specific transceiver 300 and the airborne object 368 based on the unique signature of the reflected signal 378. It is to be appreciated that the actual distance determined by the control module 326 between the specific transceiver 300 and the airborne object 368 accounts for the altitude A of the airborne object 368. In contrast, radar signals only indicate a Euclidean distance between two objects (i.e., the object that reflects the radar signal and the radar). In other words, radar signals do not account for the altitude A of the airborne object 368.

The time stamp included by the unique signature indicates a point in time when the individual signal 46a of the array of signals 46 is emitted by the specific transceiver 300. As seen in FIG. 11, the Cartesian coordinate system 310 includes an x-axis 320, a y-axis 322, and a z-axis 324. The pitch angle θ of the specific transceiver 300 indicated by the unique signature represents rotation about the y-axis 322 of the Cartesian coordinate system 310. The yaw angle Ψ of the specific transceiver 300 indicated by the unique signature represents rotation about the z-axis 324. The coordinates of the specific transceiver 300 indicated by the unique signature represent a position relative to the plane 302 where the specific transceiver 300 is located. For example, in one embodiment, the coordinates of the specific transceiver 300 are expressed as global positioning system (GPS) coordinates, however, other coordinate systems that indicate the position of the specific transceiver 300 may be used as well.

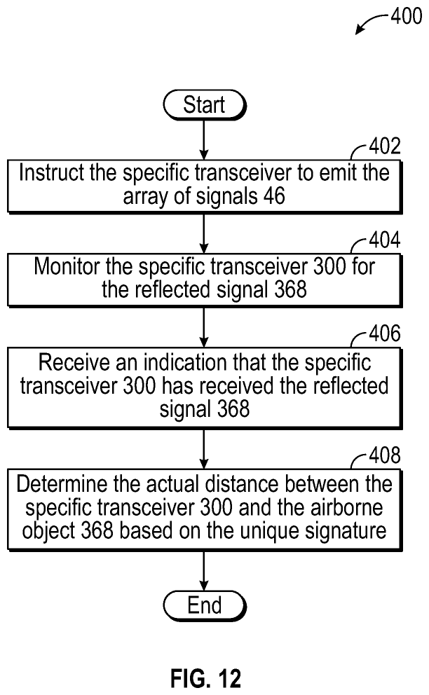

FIG. 12 is an exemplary process flow diagram illustrating a method 400 for determining the actual distance between the specific transceiver 300 and the airborne object 368. Referring specifically to FIGS. 11 and 12, the method 400 begins at block 402. In block 402, the control module 326 instructs the specific transceiver 300 to emit the array of signals 46. The method 400 may then proceed to block 404.

In block 404, the control module 326 monitors the specific transceiver for the reflected signal 378. As seen in FIG. 11, the individual signal 46a of the array of signals 46 emitted by the specific transceiver 300 reflects off an airborne object 368 to create the reflected signal 378. The method may then proceed to block 406.

In block 406, the control module 326 receives an indication that the specific transceiver 300 has received the reflected signal 378. The method 400 may then proceed to block 408.

In block 408, the control module 326 determines the actual distance between the specific transceiver 300 and the airborne object 368 based on the unique signature emitted by the individual signal 46a. The method 400 may then terminate.

Referring specifically to FIGS. 11 and 12, the disclosed system determines the actual distance between a specific transceiver and the airborne object based on the unique signature. It is to be appreciated that the actual distance accounts for the altitude of the airborne object. In contrast, radar signals are not capable of taking altitude into consideration when determining a distance between two objects, since radar only account for the yaw angle of the transceiver, and not the pitch. Accordingly, the disclosed system provides an improved approach for not only detecting airborne obstructions along an airport runway, but also determining the actual distance between the obstruction and the transceiver.

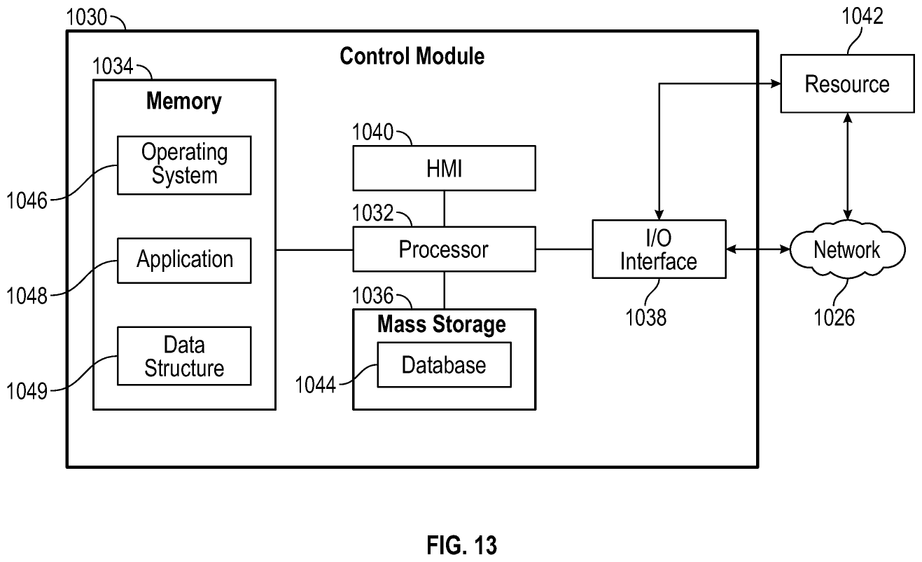

Referring now to FIG. 13, the control module 26 is implemented on one or more computer devices or systems, such as exemplary computer system 1030. The computer system 1030 includes a processor 1032, a memory 1034, a mass storage memory device 1036, an input/output (I/O) interface 1038, and a Human Machine Interface (HMI) 1040. The computer system 1030 is operatively coupled to one or more external resources 1042 via the network 1026 or I/O interface 1038. External resources may include, but are not limited to, servers, databases, mass storage devices, peripheral devices, cloud-based network services, or any other suitable computer resource that may be used by the computer system 1030.

The processor 1032 includes one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on operational instructions that are stored in the memory 1034. Memory 1034 includes a single memory device or a plurality of memory devices including, but not limited to, read-only memory (ROM), random access memory (RAM), volatile memory, non-volatile memory, static random-access memory (SRAM), dynamic random-access memory (DRAM), flash memory, cache memory, or any other device capable of storing information. The mass storage memory device 1036 includes data storage devices such as a hard drive, optical drive, tape drive, volatile or non-volatile solid-state device, or any other device capable of storing information.

The processor 1032 operates under the control of an operating system 1046 that resides in memory 1034. The operating system 1046 manages computer resources so that computer program code embodied as one or more computer software applications, such as an application 1048 residing in memory 1034, may have instructions executed by the processor 1032. In an alternative example, the processor 1032 may execute the application 1048 directly, in which case the operating system 1046 may be omitted. One or more data structures 1049 also reside in memory 1034, and may be used by the processor 1032, operating system 1046, or application 1048 to store or manipulate data.

The I/O interface 1038 provides a machine interface that operatively couples the processor 1032 to other devices and systems, such as the network 1026 or external resource 1042. The application 1048 thereby works cooperatively with the network 1026 or external resource 1042 by communicating via the I/O interface 1038 to provide the various features, functions, applications, processes, or modules comprising examples of the disclosure. The application 1048 also includes program code that is executed by one or more external resources 1042, or otherwise rely on functions or signals provided by other system or network components external to the computer system 1030. Indeed, given the nearly endless hardware and software configurations possible, persons having ordinary skill in the art will understand that examples of the disclosure may include applications that are located externally to the computer system 1030, distributed among multiple computers or other external resources 1042, or provided by computing resources (hardware and software) that are provided as a service over the network 1026, such as a cloud computing service.

The HMI 1040 is operatively coupled to the processor 1032 of computer system 1030 in a known manner to allow a user to interact directly with the computer system 1030. The HMI 1040 may include video or alphanumeric displays, a touch screen, a speaker, and any other suitable audio and visual indicators capable of providing data to the user. The HMI 1040 also includes input devices and controls such as an alphanumeric keyboard, a pointing device, keypads, pushbuttons, control knobs, microphones, etc., capable of accepting commands or input from the user and transmitting the entered input to the processor 1032.

A database 1044 may reside on the mass storage memory device 1036 and may be used to collect and organize data used by the various systems and modules described herein. The database 1044 may include data and supporting data structures that store and organize the data. In particular, the database 1044 may be arranged with any database organization or structure including, but not limited to, a relational database, a hierarchical database, a network database, or combinations thereof. A database management system in the form of a computer software application executing as instructions on the processor 1032 may be used to access the information or data stored in records of the database 1044 in response to a query, where a query may be dynamically determined and executed by the operating system 1046, other applications 1048, or one or more modules.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A system for detecting airborne objects within a shared field of view, the system comprising:
a first transceiver positioned in a first discrete location and having a first field of view that represents a detection area of the first transceiver;
a second transceiver positioned in a second discrete location and having a second field of view represents the detection area of the second field of view, wherein the first field of view and the second field of view intersect one another to create the shared field of view, and wherein both the first transceiver and the second transceiver are configured to emit an array of signals towards the shared field of view;
one or more processors in electronic communication with the first transceiver and the second transceiver; and
a memory coupled to the one or more processors, the memory storing data into a database and program code that, when executed by the one or more processors, causes the system to:
instruct either the first transceiver or the second transceiver to emit the array of signals, wherein the array of signals are configured to reflect from airborne objects located within the shared field of view to create one or more reflected signals, and wherein each signal of the array of signals includes a unique signature including information for determining an actual distance between either the first transceiver or the second transceiver and the airborne object within three-dimensional space;
monitor the first transceiver and the second transceiver for the one or more reflected signals;
receive an indication that at least one of the first transceiver and the second transceiver has received the one or more reflected signals; and
in response to receiving the indication, generate a notification indicating an airborne object is located within the shared field of view.

2. The system of claim 1, wherein the one or more processors executes instructions to:
determine the actual distance between either the first transceiver or the second transceiver based on the information included by the unique signature.

3. The system of claim 2, wherein the actual distance is measured between either the first transceiver and the second transceiver and a plane.

4. The system of claim 3, wherein the plane is a ground surface.

5. The system of claim 1, wherein the unique signature emitted by each signal of the array of signals indicates an identity of a specific transceiver that emits the array of signals.

6. The system of claim 1, wherein the unique signature emitted by each of the array of signals includes a time stamp.

7. The system of claim 1, wherein the time stamp indicates a point in time when an individual signal of the array of signals is emitted by a specific transceiver that emits the array of signals.

8. The system of claim 1, wherein the unique signature emitted by each signal of the array of signals indicates a pitch angle of a specific transceiver that emits the array of signals.

9. The system of claim 1, wherein the unique signature emitted by each signal of the array of signals indicates a yaw angle of a specific transceiver that emits the array of signals.

10. The system of claim 1, wherein the unique signature emitted by each signal of the array of signals indicates coordinates of a specific transceiver that emits the array of signals.

11. The system of claim 10, wherein the coordinates of the specific transceiver are expressed as global positioning system (GPS) coordinates.

12. The system of claim 1, wherein the one or more processors execute instructions to:
generate a rasterized representation of the shared field of view, wherein the rasterized representation of the shared field of view is divided into a plurality of pixels, and wherein each of the plurality of pixels correspond to an individual signal of the array of signals.

13. A system for detecting airborne objects along a runway for landing and takeoff of an aircraft, wherein the aircraft follows a flight path during takeoff or landing, wherein the system comprises:
a first transceiver positioned in a first discrete location at a first end of the runway and having a first field of view that represents a detection area of the first transceiver;
a second transceiver positioned in a second discrete location at a second end of the runway and having a second field of view represents the detection area of the second field of view, wherein the first field of view and the second field of view intersect one another to create a shared field of view, and wherein both the first transceiver and the second transceiver are configured to emit an array of signals towards the shared field of view;
one or more processors in electronic communication with the first transceiver and the second transceiver; and
a memory coupled to the one or more processors, the memory storing data into a database and program code that, when executed by the one or more processors, causes the system to:
instruct either the first transceiver or the second transceiver to emit the array of signals, wherein the array of signals are configured to reflect from airborne objects located within the shared field of view to create one or more reflected signals, and wherein each signal of the array of signals includes a unique signature including information for determining an actual distance between either the first transceiver or the second transceiver and the airborne object within three-dimensional space;
monitor the first transceiver and the second transceiver for the one or more reflected signals;
receive an indication that at least one of the first transceiver and the second transceiver has received the one or more reflected signals; and
in response to receiving the indication, generate a notification indicating an airborne object is located within the shared field of view, wherein at least a portion of the flight path of the aircraft is located within the shared field of view.

14. The system of claim 13, wherein the one or more processors executes instructions to:
determine the actual distance between either the first transceiver or the second transceiver based on the information included by the unique signature.

15. The system of claim 14, wherein the unique signature indicates an identity of a specific transceiver that emits the array of signals, a time stamp, a pitch angle of the specific transceiver, a yaw angle of the specific transceiver, and coordinates of the specific transceiver.

16. The system of claim 13, wherein the one or more processors executes instructions to:
generate a rasterized representation of the shared field of view, wherein the rasterized representation of the shared field of view is divided into a plurality of pixels, wherein each of the plurality of pixels correspond to an individual signal of the array of signals.

17. A method for detecting airborne objects within a shared field of view between a first transceiver and a second transceiver, the method comprising:
instructing, by a computer, either the first transceiver or the second transceiver to emit an array of signals, wherein the array of signals are configured to reflect from airborne objects located within the shared field of view to create one or more reflected signals, the shared field of view is created as a first field of view of the first transceiver and a second field of view of a second transceiver intersect one another, and each signal of the array of signals includes a unique signature including information for determining an actual distance between either the first transceiver or the second transceiver and the airborne object within three-dimensional space;
monitoring, by the computer, the first transceiver and the second transceiver for the one or more reflected signals;
receiving, by the computer, an indication that at least one of the first transceiver and the second transceiver has received the one or more reflected signals; and
in response to receiving the indication, generating a notification indicating an airborne object is located within the shared field of view.

18. The method of claim 17, further comprising:
determine the actual distance between either the first transceiver or the second transceiver based on the information included by the unique signature, wherein the unique signature indicates an identity of a specific transceiver that emits the array of signals, a time stamp, a pitch angle of the specific transceiver, a yaw angle of the specific transceiver, and coordinates of the specific transceiver.

19. The method of claim 17, further comprising:
generating a rasterized representation of the shared field of view, wherein the rasterized representation of the shared field of view is divided into a plurality of pixels, wherein each of the plurality of pixels correspond to an individual signal of the array of signals.

20. The method of claim 19, further comprising:
rendering each of the plurality of pixels of the rasterized representation sequentially while monitoring the first transceiver and the second transceiver for the one or more reflected signals.
